(19) United States
(12) Patent Application Publication
(10) Pub. No.: US 2021/0114598 A1
(43) Pub. Date: Apr. 22, 2021

(54) METHOD FOR NEUTRAL COASTING CONTROL BASED ON FUEL INJECTION CONDITION REINFORCEMENT AND NEUTRAL COASTING CONTROL SYSTEM THEREOF

(71) Applicants: HYUNDAI MOTOR COMPANY, Seoul (KR); KIA MOTORS CORPORATION, Seoul (KR)

(72) Inventors: Jung-Sup Byun, Seongnam-si (KR); Seung-Woo Lee, Seoul (KR); Chan-Hee Won, Seoul (KR)

(21) Appl. No.: 16/825,530

(22) Filed: Mar. 20, 2020

(30) Foreign Application Priority Data
Oct. 21, 2019 (KR) 10-2019-0130831

(51) Int. Cl. B60W 30/18; B60W 10/06; B60W 10/10

(52) U.S. Cl. CPC B60W 30/18072; B60W 10/06; B60W 10/10; B60W 2510/02; B60W 2510/0638; B60W 2510/1015; B60W 2510/182

(57) ABSTRACT

A neutral coasting control (NCC) method based on fuel injection condition reinforcement applied to an NCC system is provided. The NCC method comprises in response to a controller detecting pressing of a brake pedal of a pedal system being switched to an NCC release from an operation, practice, or action of an NCC of a vehicle, fuel injection condition reinforcement control for delaying a fuel injection of a fuel injector. The delay of the fuel injection is according to a fuel injection stop condition for a predetermined time. The fuel injection delay is stopped according to a fuel injection stop abort condition and a fuel injection stop release condition. Fuel injection start control to stop or start the fuel injection according to a state of an engine overrun after transmission direct connection state is established such that improvement of fuel efficiency can be achieved by preventing an unnecessary fuel injection through delaying and limiting of the fuel injection start.

### CROSS-REFERENCE TO RELATED APPLICATION

This application claims priority to Korean Patent Application No. 10-2019-0130831, filed on Oct. 21, 2019, which is incorporated herein by reference in its entirety.

### BACKGROUND OF PRESENT DISCLOSURE

### Field of Present Disclosure

Exemplary embodiments of the present disclosure relate to neutral coasting control (NCC). More particularly, the present disclosure relates to an NCC system implementing NCC by reinforcing a fuel injection condition which delays a fuel injection from an NCC release time to a specific predetermined time due to a brake pedal manipulation.

### Description of Related Art

Generally, neutral coasting control (NCC) of a vehicle is implemented as an operation, practice, or action through an NCC execution condition in engine idle control and transmission neutral control and then stopped in an NCC release condition.

For example, execution of the NCC is performed when the vehicle, in which an automatic transmission, a double clutch transmission (DCT), an automated manual transmission (AMT), an intelligent manual transmission (iMT), or the like is applied as a transmission, is switched to a situation of engine idle control and transmission neutral control. In this case, a transmission control unit (TCU) blocks power transmission (i.e., a clutch off) according to the execution of the NCC, thereby improving fuel efficiency through an increase of a driving distance due to extension of a coasting section.

On the other hand, a release of the NCC sets a manipulation of a brake pedal or an accelerator pedal by a driver as an NCC release time to switch to a fuel injection stop or a fuel injection start according to a fuel cut off condition after transmission torque cooperative control (that is, after control for requesting a torque increase through cooperative control for direct connection control because the transmission is in a neutral stage during the NCC operation).

However, after the execution of the NCC, the operation, practice, or action of the NCC performs an unnecessary fuel injection while the driver manipulates the brake pedal such that a loss of fuel efficiency may occur.

For example, after the execution of the NCC, the NCC release time subsequent to the operation, practice, or action of the NCC may be set by the brake pedal manipulation of the driver, which means inertia driving of the vehicle in which an acceleration intent of the driver is not present, and, at the NCC release time due to the brake pedal manipulation, during the inertia driving, fuel cut off control capable of being executed in a fuel cut off revolution per minute (RPM) (i.e., a fuel cut off in RPM) of an engine is not considered such that an unnecessary fuel injection resulting in a loss of fuel efficiency is being performed.

### SUMMARY OF PRESENT DISCLOSURE

An embodiment of the present disclosure is directed to a neutral coasting control (NCC) method based on fuel injection condition reinforcement and an NCC system thereof, which are capable of achieving an improved fuel efficiency by allowing the start of fuel injection to be delayed and restricted in consideration of fuel cut off control. This is accomplished due to inertia driving, in which an acceleration intent of a driver is not present in a state of operating, practicing, or acting NCC and in an NCC release state, and, particularly, capable of rapidly responding to the acceleration intent of the driver, which may occur at an NCC release time, by checking in multiple a delay of the fuel injection start with a stop condition, a release condition, and an abort condition.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

In accordance with an embodiment of the present disclosure, there is provided a neutral coasting control (NCC) method comprising a controller determining an NCC release from an operation, practice, or action of NCC of a vehicle, and fuel injection condition reinforcement control for stopping a fuel injection of a fuel injector for a predetermined delay time according to a fuel injection stop condition and then stopping a delay of the fuel injection according to a fuel injection stop abort condition and a fuel injection stop release condition.

As an exemplary embodiment, pressing of a brake pedal may be applied as a condition of the NCC release.

As an exemplary embodiment, the fuel injection condition reinforcement control may include a fuel injection stop execution control for establishing the fuel injection stop condition with respect to a fuel injection stop for the predetermined delay time, and a fuel injection stop switch control for establishing the fuel injection stop abort condition and the fuel injection stop release condition for converting the fuel injection stop into a fuel injection start.

As an exemplary embodiment, the fuel injection stop execution control may include determining whether the fuel injection stop condition is satisfied on the basis of detection information according to the NCC release, raising an engine revolution per minute (RPM) after the fuel injection stop condition is performed, and counting and accumulating the predetermined delay time so as to maintain a state of the fuel injection stop.

As an exemplary embodiment of the fuel injection stop execution control, check conditions for satisfaction of the fuel injection stop condition may include a transmission slip control execution condition, an NCC release condition due to a brake pedal, an RPM application condition, an RPM range condition, a vehicle speed condition, and a system condition. Satisfaction of the fuel injection stop condition may be achieved when each of the check conditions is satisfied.

As an exemplary embodiment of the fuel injection stop execution control, the raising of the engine revolution per minute (RPM) may be achieved by vehicle inertia due to the NCC. The counting of the predetermined delay time may be set to a fuel injection stop time to which the vehicle speed and the transmission RPM are applied.

As an exemplary embodiment, after the fuel injection stop abort condition is determined, the fuel injection stop switch control may determine the fuel injection stop release condition.

As an exemplary embodiment of the fuel injection stop switch control, check conditions for the fuel injection stop abort condition may include an acceleration condition, a gear shift condition, an RPM application condition, a fuel injection start condition, and an external torque request condition. Satisfaction of the fuel injection stop abort condition may be achieved when any one among the check conditions is satisfied.

As an exemplary embodiment of the fuel injection stop switch control, after the fuel injection stop release condition is determined, the fuel injection stop switch control may determine the fuel injection stop release condition. Check conditions for the fuel injection stop release condition may include a delay time condition and a controller area network (CAN) clutch signal condition. Satisfaction of the fuel injection stop release condition may be achieved when any one of the check conditions is satisfied.

As an exemplary embodiment, after the fuel injection delay is stopped, fuel injection start control may be performed, and the fuel injection start control may include establishing a transmission direct connection state through transmission torque cooperative control, and determining whether to stop and start the fuel injection in a state of an engine overrun for the fuel cut execution determination.

In accordance with another embodiment of the present disclosure, there is provided a neutral coasting control (NCC) system including a controller configured to perform fuel injection condition reinforcement control in which, when pressing a brake pedal of a pedal system which is switched to an NCC release from an operation, practice, or action of an NCC of a vehicle, a fuel injection from a fuel injector is delayed for a determined period of time according to a fuel injection stop condition with respect to a powertrain engine. The fuel injection delay ends in response to a fuel injection stop abort condition and a fuel injection stop release condition. Fuel injection start control to determine whether to stop or start the fuel injection according to a state of an engine overrun where the required torque of the engine is low enough that torque generation by fuel injection is not necessary after a transmission direct connection state is established.

As an exemplary embodiment, the controller may operate in conjunction with a fuel injection stop timer, and the fuel injection stop timer may count a delay time for the determined period of time.

As an exemplary embodiment, the powertrain may include a 48V mild hybrid starter and generator (MHSG).

### BRIEF DESCRIPTION OF THE DRAWINGS

FIG. 1 is a flowchart illustrating a neutral coasting control (NCC) method based on fuel injection condition reinforcement according to the present disclosure.

FIG. 2 is a diagram illustrating an example of an NCC system based on fuel injection condition reinforcement according to the present disclosure.

FIG. 3 is a diagram illustrating a state of the NCC during coasting driving of the NCC system according to the present disclosure.

FIG. 4 is a diagram illustrating an example of a fuel injection start time delay graph in which a fuel injection stop is performed so as to prevent an unnecessary fuel injection during the NCC based on fuel injection condition reinforcement according to the present disclosure.

### DESCRIPTION OF SPECIFIC EMBODIMENTS

Exemplary embodiments of the present disclosure will be described in detail below with reference to the accompanying drawings, and these embodiments are examples of the present disclosure and may be embodied in various other different forms by those skilled in the art to which the present disclosure pertains so that the present disclosure is not limited to these embodiments.

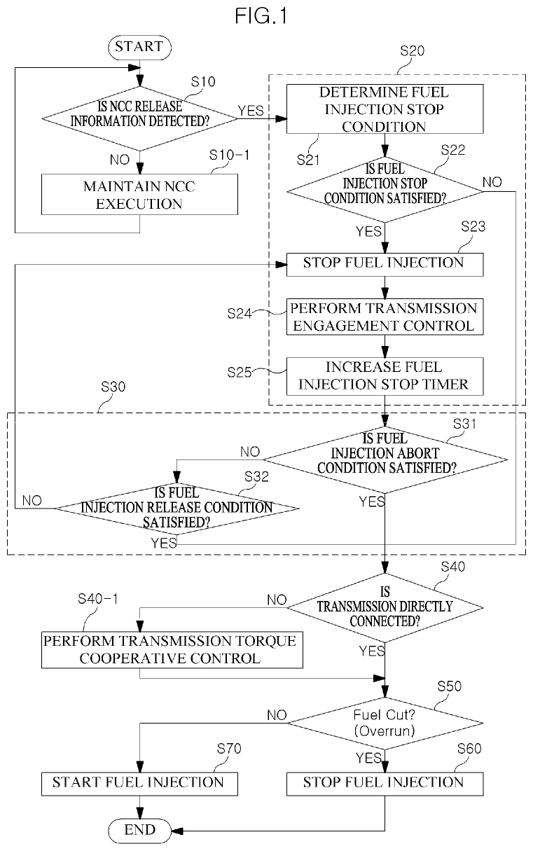

Referring to FIG. 1, in a neutral coasting control (NCC) release information detection state (S10), an NCC method performs fuel injection start control (S40 to S70) after fuel injection condition reinforcement control (S20 and S30).

In particular, the fuel injection condition reinforcement control (S20 and S30) includes fuel injection stop execution control (S20) for establishing a stop condition with respect to a delay of a fuel injection start and fuel injection stop switch control (S30) for establishing a release condition and an abort condition with respect to a fuel injection stop, and all various conditions of a vehicle are taken into account in delaying and blocking the fuel injection start.

Therefore, the NCC method is characterized as an NCC method based on fuel injection condition reinforcement. Thus, when a driver encounters an NCC release condition by stepping on a brake pedal from a state of an operation, practice, or action of the NCC after execution of the NCC, the NCC method based on fuel injection condition reinforcement stops a fuel injection for a certain period of time to maintain the vehicle in a fuel cut control state. It is thus possible to achieve maximization of fuel efficiency by preventing a fuel injection from being unnecessarily performed during inertial driving in which an acceleration intent of the driver is not present.

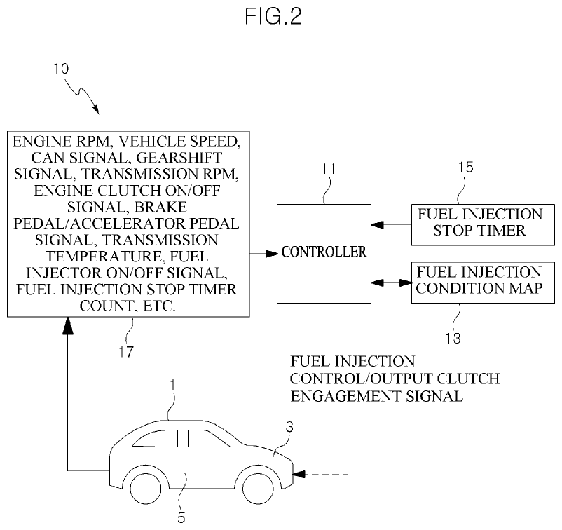

Referring to FIG. 2, a vehicle 1 includes a powertrain 3, a pedal system 5, and an NCC system 10.

In an example embodiment, the powertrain 3 includes an engine which is controlled by an engine electronic control unit (ECU), a 48V mild hybrid starter and generator (MHSG), a transmission (e.g., a double clutch transmission (DCT), an automated manual transmission (AMT), or an intelligent manual transmission (iMT)) which is controlled by a transmission control unit (TCU), and a clutch. In this embodiment, the 48V MHSG includes a motor operating as electric power generation while starting the engine, a 48V battery, a low voltage direct current (DC)/DC converter (LDC), and a starter. The pedal system 5 includes a brake pedal and an accelerator pedal. Therefore, the vehicle 1 may be a hybrid vehicle, particularly, a 48V mild hybrid electric vehicle.

For example, the NCC system 10 includes a controller 11, a fuel injection condition map 13, a fuel injection stop timer 15, and a data input part 17.

The controller 11 includes a memory in which a logic for the fuel injection condition reinforcement control (S20 and S30) and the fuel injection start control (S40 to S70) is programmed and stored, and a central processing unit for generating a fuel injection control signal output. The fuel injection condition map 13 matches input data of the data input part 17 to a stop condition, a release condition, and an abort condition with respect to the fuel injection. The fuel injection stop timer 15 counts or determines a fuel injection stop time.

The data input part 17 transmits, as input data, one or more of an engine revolution per minute (RPM), a vehicle speed, a controller area network (CAN) signal, a gearshift signal, a transmission RPM, a clutch RPM, an engine clutch ON/OFF signal, a brake pedal/accelerator pedal signal, a transmission temperature, a fuel injector ON/OFF signal, a fuel injection stop timer count, an MHSG motor signal, a fuel cut ON/OFF signal, and the like to the controller 11. Therefore, the engine ECU may be applied to the data input part 17.

Hereinafter, the NCC method based on fuel injection condition reinforcement will be described in detail with reference to FIGS. 2 to 4. In this embodiment, a control main body is the controller 11, and a control target is the powertrain 3 of which starting is performed by an MHSG system and a fuel injection timing is controlled by a fuel injector.

First, the controller 11 determines whether NCC release information is detected (S10) and then maintains NCC execution when an NCC release condition is not satisfied from a state of the operation, practice, action of the NCC (i.e., an NCC execution state) (S10-1, whereas, when the NCC release condition is satisfied, the controller 11 proceeds to the fuel injection condition reinforcement control (S20 and S30).

Referring to FIG. 2, the controller 11 reads the engine RPM, the vehicle speed, the CAN signal, the gearshift signal, the transmission RPM, the engine clutch ON/OFF signal, the brake pedal/accelerator pedal signal, the transmission temperature, the fuel injector ON/OFF signal, the fuel injection stop timer count, which comprise the input data of the data input part 17, and, among the input data, checks whether the brake pedal signal is generated according to pressing of the brake pedal to apply generation of the brake pedal signal as the NCC release information (S10). In this embodiment, generation of the brake pedal signal is detected by a brake pedal position sensor (BPS), and generation of the accelerator pedal signal is detected by an accelerator pedal position sensor (APS) (not shown).

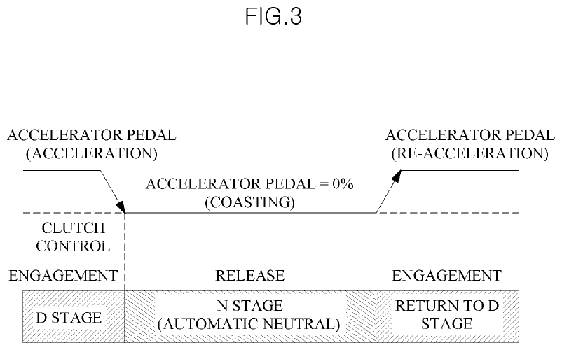

Referring to FIG. 3, the NCC is performed by setting an APS=0% section, in which the accelerator pedal is not stepped on between acceleration and re-acceleration due to an accelerator pedal manipulation as an NCC control section.

As shown in the drawing, transmission control of the TCU maintains a clutch engagement state according to a drive (D) stage gear-shift state in an accelerator pedal acceleration section, automatically switches to a neutral (N) stage gear-shift in the NCC control section, and thus switches to a clutch engagement state according to a gear-shift state of returning to the D stage in an accelerator pedal re-acceleration section.

Referring to FIG. 1 again, the controller 11 establishes the stop condition in which the fuel injection is delayed for a certain period of time using the fuel injection stop execution control (S20) of the fuel injection condition reinforcement control (S20 and S30) and establishes the release condition and the abort condition in which the fuel injection start is performed after the fuel injection stop using the fuel injection stop switch control (S30).

Specifically, the fuel injection stop execution control (S20) includes a fuel injection stop condition checking (S21), a fuel injection stop condition satisfaction determination (S22), and fuel injection delay control (S23 to S25).

For example, the stop condition is applied to the fuel injection stop condition checking (S21) and the fuel injection stop condition satisfaction determination (S22). The stop condition is determined as the following fuel injection stop condition check list using the vehicle speed, the engine RPM, the transmission RPM, the clutch RPM, the CAN signal, the brake pedal/accelerator pedal signal, the fuel injector signal, the MHSG motor signal, the fuel cut ON/OFF signal, and the like among the input data of the data input part 17.

Examples of a fuel injection stop condition check list are provided as follows:
A: Transmission slip control execution condition (e.g., checking using the CAN signal)
B: NCC release condition due to the brake pedal
C: RPM application condition (e.g. transmission turbine RPM or clutch RPM>RPM threshold set in consideration of the vehicle speed or fuel cut execution request engine RPM)
D: RPM area condition (e.g. RPM difference (engine RPM−transmission RPM)<RPM threshold set in consideration of the vehicle speed and the transmission temperature or ascendable engine RPM range set in consideration of transmission slip control)
E: Vehicle speed condition (e.g., lower limit vehicle speed threshold (Threshold 1)<vehicle speed<upper limit vehicle speed threshold (Threshold 2))
F: System status condition (e.g., a MHSG motor failure signal is not generated, an injector related failure signal is not generated, a brake pedal failure signal is not generated, a transmission CAN failure signal is not generated, and a transmission RPM failure signal is not generated)

In this case, “<” and “>” are inequality signs indicating a magnitude relationship between two values. Further, since A, B, C, D, E, and F (which form the fuel injection stop condition check list) are “AND conditions,” each condition should be satisfied in the fuel injection stop condition satisfaction determination (S22).

Thus, when any one among the fuel injection stop condition check list: A, B, C, D, E, and F, is not satisfied during a check of the fuel injection stop condition (S21), the controller 11 switches to the fuel injection start control (S40 to S70). When all of the elements of the fuel injection stop condition check list: A, B, C, D, E, and F, are satisfied during a check of the fuel injection stop condition (S21), the controller 11 executes the fuel injection delay control (S23 to S25) to stop a fuel injection of the fuel injector.

Specifically, the controller 11 performs the fuel injection delay control (S23 to S25) to stop fuel injection (S23), a transmission control performance (S24), and a fuel injection stop time (timer) accumulation (S25).

For example, the fuel injector stops a fuel injection at (S23) because all of A, B, C, D, E, and F (as applied to the fuel check of the injection stop condition (S21)) are satisfied. The transmission control performance (S24) is transmission engagement control and raises the engine RPM using vehicle inertia in an NCC state such that a clutch (e.g., an engine clutch) is directly connected between the engine and the transmission.

For example, at the fuel injection stop time accumulation step (S25), the fuel injection stop timer 15 determines or counts a fuel injection stop time at a time of the fuel injection stopping (S23) and transmits the counted fuel injection stop time to the controller 11. In this case, a fuel injection stop time count range is set as a fuel injection stop time T.

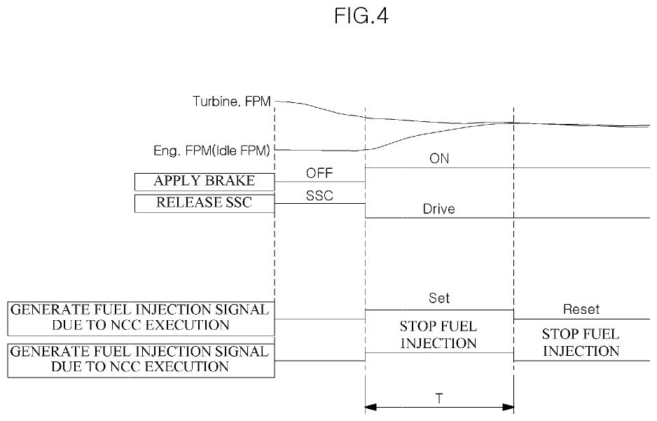

Referring to FIG. 4, a fuel injection start time delay graph is divided into a transmission RPM variation state in which RPM is reduced (e.g., turbine), an engine RPM variation state (e.g., idle) in which RPM is increased for a clutch direct connection (i.e., reaching a clutch RPM), a brake application state according to the brake pedal manipulation (e.g., BPS ON/OFF), an NCC state in which coasting driving has a release condition (e.g., start/stop coasting (SSC), a fuel injection stop execution condition state (e.g., execution: SET and execution release: RESET), and a fuel injection stop signal state (e.g., T: delay time of fuel injection start time).

As shown in FIG. 4, when a state of the fuel injection stop execution condition is maintained in a SET section of a fuel injection stop state before being switched to a RESET section, the fuel injection stop signal state is counted and accumulated during the fuel injection stop time T. Therefore, duration of the SET section and duration of the delay time T of the fuel injection start time are continued until an abort condition (S31) or a release condition (S32) of the fuel injection stop switch control (S30) is satisfied.

In particular, the fuel injection stop according to the SET section generates a new signal in a corresponding situation according to satisfaction of a fuel injection stop logic execution conditions and uses the generated new signal as an input factor of the existing fuel cut functional logic such that the generated new signal is used as an input of the injector module to prevent the fuel injection.

Referring to FIG. 1 again, the controller 11 performs the fuel injection stop switch control S30 by dividing into the abort condition (S31) and the release condition (S32).

For example, the abort condition (S31) applies the abort condition. The stop condition is determined as the following fuel injection abort condition check list using the engine RPM, the accelerator pedal signal, the fuel cut ON/OFF signal, and the like among the input data of the data input part 17.

Examples of fuel injection abort condition check list are provided as follows:
H: Acceleration condition (e.g., accelerator pedal>0%)
I: gear shift condition (e.g. change of gear stages)
J: RPM application condition (e.g., engine RPM<fuel cut execution request engine RPM in an operating state of the engine)
K: Fuel injection start condition (e.g., fuel cut off execution)
L: External torque request condition (including an emergency situation, e.g., an anti-lock brake system (ABS), an electronic stability control (ESC), a brake traction control system (TCS), or the like)

In this embodiment, “<” and “>” are inequality signs indicating a magnitude relationship between two values. Further, since H, I, J, K, and L (which form the fuel injection abort condition check list) are “OR conditions,” any one among the conditions may be satisfied in the abort condition determination (S31).

Thus, when any one among the fuel injection stop condition check list: H, I, J, K, and L, is satisfied in the abort condition determination (S31), the controller 11 switches to the fuel injection start control (S40 to S70); and in turn, when none of H, I, J, K, and L are satisfied in the abort condition determination (S31), the controller 11 executes the fuel injection release condition (S32).

For example, the release condition (S32) applies the release condition. The release condition is determined as the following fuel injection release condition check list using the delay time T of the fuel injection start time of the fuel injection stop timer 15 together with a CAN, a clutch engagement, the vehicle speed, the engine RPM, and the transmission RPM among the input data of the data input part 17.

Examples of fuel injection release condition check list are provided as follows:
M: Delay time condition (e.g., delay time T of the fuel injection start time>delay time threshold according to a fuel injection request in consideration of the vehicle speed and the transmission RPM)
N: CAN clutch signal condition (e.g., elapsing of a delay time threshold of the delay time T of the fuel injection start time after the transmission engagement control is completed according to an NCC release)

In this embodiment, “>” is an inequality sign indicating a magnitude relationship between two values. Further, since M and N, which form the fuel injection release condition check list, are “OR conditions,” either of the conditions may be satisfied in the release condition determination (S32).

Thus, when either of M and N (which form the fuel injection release condition check list) is satisfied in the release condition determination (S32), the controller 11 switches to the fuel injection start control (S40 to S70); in turn, when neither M nor N is satisfied in the release condition determination (S32), the controller 11 returns to the fuel injection stopping.

The controller 11 performs the fuel injection start control (S40 to S70) continuously as transmission setting-up (S40 and S40-1) and fuel injection start final determination (S50 to S70).

Specifically, in the transmission setting-up (S40 and S40-1), a transmission direct engagement checking (S40) determines whether a transmission direct connection is made in S24. As the determination result, when the transmission direct connection is not made, a transmission torque cooperative control (S40-1) is executed to complete the transmission direct connection (e.g., s clutch direct connection). In this case, the transmission direct connection is in a state in which a slip is not present between the engine and the transmission.

Specifically, in the fuel injection start final determination (S50 to S70), a state of an engine overrun is determined in a fuel cut condition checking (S50). As the determination result, in the case of a fuel cut condition due to the overrun, a fuel injection stopping (S60) is continued, whereas, in the case of the fuel cut condition due to the overrun, a fuel injection starting (S70) is performed. In this case, the engine overrun means a state in which, when a vehicle is driving over a predetermined vehicle speed, the required torque of the engine is low enough that torque generation by fuel injection is not necessary. Therefore, in the engine overrun, a driver does not step on an accelerator pedal because no further output is required.

As described above, when the NCC is executed in the NCC system 10, through the NCC method based on fuel injection condition reinforcement, the controller 11 may maintain the fuel injection for engine idle control, perform the transmission torque cooperative control with respect to a torque increase request for direct connection control of the transmission, which is in a neutral state, from the operation, practice, or action of the NCC, and maintain coasting of the vehicle due to inertia. Further, after the NCC is executed in the NCC system 10, even when the driver steps on the brake pedal to execute the NCC release from a state of the operation, practice, or action of the NCC, the controller 11 may implement a feature which is capable of maintaining a fuel cut state in which the fuel injection is not present at a time of the NCC release so as to achieve maximum fuel efficiency through prevention of an unnecessary fuel injection when the NCC is released due to a brake pedal condition.

As described above, when the controller 11 detects pressing of the brake pedal of the pedal system 5 in which a state of the operation, practice or action of the NCC of the vehicle is switched to the NCC release, the NCC method based on fuel injection condition reinforcement applied to the NCC system 10 according to the present embodiment includes the fuel injection condition reinforcement control (S20 and S30), which delays the fuel injection of the fuel injector according to the fuel injection stop condition for a certain period of time and then stops the fuel injection delay according to the fuel injection stop abort condition and the fuel injection stop release condition, and the fuel injection start control (S40 to S70) to stop or start the fuel injection according to a state of the engine overrun after establishing the transmission direct connection state such that it is possible to achieve improvement of fuel efficiency by preventing an unnecessary fuel injection through delaying and limiting of the fuel injection start. In particular, it is possible to rapidly respond to the acceleration intent of the driver, which will occur at a time of the NCC release, according to various situation determinations to which the fuel injection stop release condition and the abort condition.

The above-described NCC applied to the NCC system of the present disclosure implements the following actions and effects by reinforcing the fuel injection condition with respect to the NCC release.

First, when the NCC is released due to the brake pedal condition from the state of the operation, practice, or action of the NCC, it is possible to contribute to improvement of fuel efficiency by preventing an unnecessary fuel injection through stopping of the fuel injection for a certain period of time, performing the fuel cut off execution of the vehicle, and delaying of the time of the fuel injection start during a time of the fuel cut off execution. Second, prevention of the fuel injection is performed by dividing into the fuel injection stop execution condition, the fuel injection release condition and the abort execution condition such that it is possible to obtain an effect of fuel efficiency improvement so as to achieve maximization of fuel efficiency which can occur at the time of the NCC release. Third, the NCC release is divided into the accelerator pedal operation and the brake pedal operation such that, when the NCC is released due to the accelerator pedal, reflection of the acceleration intent of the driver can be directly maintained. Fourth, it is possible to implement an effect of more improved fuel efficiency with a vehicle to which the automatic transmission, the DCT, the AMT, and the iMT, or the like is applied using the NCC system and implementing the NCC based on fuel injection condition reinforcement in the fuel injection condition.

While the present disclosure has been described with respect to the specific embodiments, it will be apparent to those skilled in the art that various changes and modifications may be made without departing from the spirit and scope of the present disclosure as defined in the following claims. Accordingly, it should be noted that such alternations or modifications fall within the claims of the present disclosure, and the scope of the present disclosure should be construed on the basis of the appended claims.

What is claimed is:

1. A neutral coasting control (NCC) method, comprising:
in response to a controller determining an NCC release from an operation, practice, or action of NCC of a vehicle, fuel injection condition reinforcement control for:
stopping a fuel injection of a fuel injector for a predetermined delay time according to a fuel injection stop condition, and
stopping a delay of the fuel injection according to a fuel injection stop abort condition and a fuel injection stop release condition.

2. The NCC method of claim 1, further comprising:
pressing of a brake pedal is applied as a condition of the NCC release.

3. The NCC method of claim 1, wherein the fuel injection condition reinforcement control includes:
establishing, via a fuel injection stop execution control, the fuel injection stop condition with respect to a fuel injection stop for the predetermined delay time; and
establishing, via a fuel injection stop switch control, the fuel injection stop abort condition and the fuel injection stop release condition for converting the fuel injection stop into a fuel injection start.

4. The NCC method of claim 3, wherein the fuel injection stop execution control includes:
determining whether the fuel injection stop condition is satisfied on the basis of detection information according to the NCC release;
raising an engine revolution per minute (RPM) after the fuel injection stop condition is performed; and
counting and accumulating the predetermined delay time so as to maintain a state of the fuel injection stop.

5. The NCC method of claim 4, wherein check conditions for satisfaction of the fuel injection stop condition include a transmission slip control execution condition, an NCC release condition due to a brake pedal, an RPM application condition, an RPM range condition, a vehicle speed condition, and a system condition.

6. The NCC method of claim 5, wherein satisfaction of the fuel injection stop condition is achieved when each of the check conditions is satisfied.

7. The NCC method of claim 4, wherein the raising of the engine RPM is achieved by vehicle inertia due to the NCC.

8. The NCC method of claim 4, wherein the counting of the predetermined delay time is set to a fuel injection stop time, and the fuel injection stop time is set to the vehicle speed and the transmission RPM.

9. The NCC method of claim 3, wherein, after the fuel injection stop abort condition is determined, determining via the fuel injection stop switch control the fuel injection stop release condition.

10. The NCC method of claim 9, wherein check conditions for the fuel injection stop abort condition include an acceleration condition, a gear shift condition, an RPM application condition, a fuel injection start condition, and an external torque request condition.

11. The NCC method of claim 10, wherein satisfaction of the fuel injection stop abort condition is achieved when any one among the check conditions is satisfied.

12. The NCC method of claim 3, wherein, after the fuel injection stop release condition is determined, determining via the fuel injection stop switch control the fuel injection stop release condition.

13. The NCC method of claim 12, wherein check conditions for the fuel injection stop release condition include a delay time condition and a controller area network (CAN) clutch signal condition.

14. The NCC method of claim 13, wherein satisfaction of the fuel injection stop release condition is achieved when any one of the check conditions is satisfied.

15. The NCC method of claim 1, wherein:
after the fuel injection delay is stopped, fuel injection start control is performed;
the fuel injection start control includes:
establishing a transmission direct connection state through transmission torque cooperative control; and
determining whether to stop and start the fuel injection in a state of an engine overrun.

16. The NCC method of claim 15, wherein the engine overrun is used to determine a fuel cut execution.

17. A neutral coasting control (NCC) system, comprising:
a controller configured to perform fuel injection condition reinforcement control in which, when pressing of a brake pedal of a pedal system which is switched to an NCC release from an operation, practice, or action of an NCC of a vehicle is detected, a fuel injection of a fuel injector is delayed for a certain period of time according to a fuel injection stop condition with respect to an engine of a powertrain and then the fuel injection delay is stopped according to a fuel injection stop abort condition and a fuel injection stop release condition, and fuel injection start control for whether to stop or start the fuel injection according to a state of an engine overrun after a transmission direct connection state is established.

18. The NCC system of claim 17, wherein the controller is in conjunction with a fuel injection stop timer, and the fuel injection stop timer counts a time of the delay for the certain period of time.

19. The NCC system of claim 17, wherein the powertrain includes a 48V mild hybrid starter and generator (MHSG).
